(19) United States
(12) Patent Application Publication
(10) Pub. No.: US 2026/0152013 A1
(43) Pub. Date: Jun. 4, 2026

(54) LIQUID APPLYING APPARATUS

(71) Applicant: Hideaki SUZUKI, Kanagawa (JP)

(72) Inventor: Hideaki SUZUKI, Kanagawa (JP)

(21) Appl. No.: 19/333,414

(22) Filed: Sep. 19, 2025

(30) Foreign Application Priority Data
Dec. 4, 2024 (JP) 2024-211543

(51) Int. Cl. B41J 11/00; B41J 13/08; F24F 6/02

(52) U.S. Cl. CPC B41J 11/0024; B41J 13/08; F24F 6/025

(57) ABSTRACT

A liquid applying apparatus includes a liquid applier, a conveyor, a humidifier, and a dielectric heater. The liquid applier applies liquid to a print target. The conveyor conveys the print target to the liquid applier along a conveyance path in a conveyance direction. The humidifier is disposed upstream from the liquid applier in the conveyance direction. The humidifier applies water to the print target on the conveyance path. The dielectric heater is disposed downstream from the humidifier and upstream from the liquid applier in the conveyance direction. The dielectric heater heats the print target on the conveyance path and supplies the water generated from the print target to the humidifier.

### CROSS-REFERENCE TO RELATED APPLICATION

This patent application is based on and claims priority pursuant to 35 U.S.C. § 119(a) to Japanese Patent Application No. 2024-211543, filed on Dec. 4, 2024, in the Japan Patent Office, the entire disclosure of which is hereby incorporated by reference herein.

### BACKGROUND

### Technical Field

The present disclosure relates to a liquid applying apparatus.

### Related Art

In the art, an inkjet printer blows hot air onto a print target (e.g., a sheet) to which pretreatment liquid adheres or presses a heat roller against the print target while conveying the print target to thermally dry the pretreatment liquid before printing.

### SUMMARY

The present disclosure described herein provides an improved liquid applying apparatus including a liquid applier, a conveyor, a humidifier, and a dielectric heater. The liquid applier applies liquid to a print target. The conveyor conveys the print target to the liquid applier along a conveyance path in a conveyance direction. The humidifier is disposed upstream from the liquid applier in the conveyance direction. The humidifier applies water to the print target on the conveyance path. The dielectric heater is disposed downstream from the humidifier and upstream from the liquid applier in the conveyance direction. The dielectric heater heats the print target on the conveyance path and supplies the water generated from the print target to the humidifier.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a side view of a liquid applying apparatus;

FIG. 2 is a side view of a humidifier used in a liquid applying apparatus;

FIG. 3A is a perspective view of a dielectric heater used in a liquid applying apparatus;

FIG. 3B is a side view of a dielectric heater; and

FIG. 4 is a perspective view of a dielectric heater using a microwave heater.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

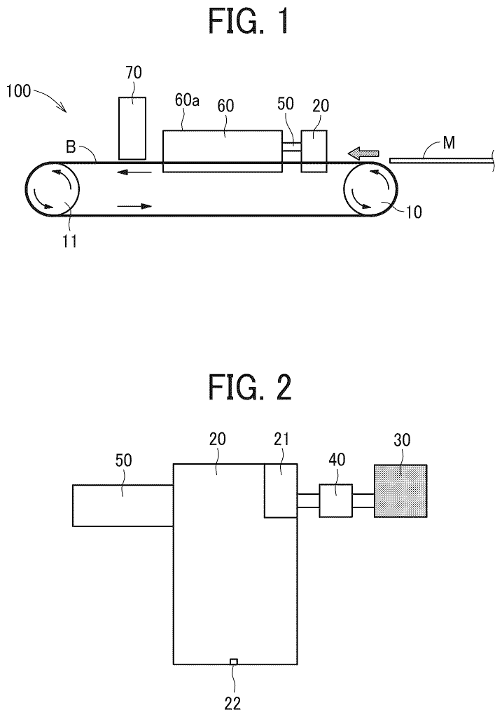

A liquid applying apparatus 100 will be described below with reference to FIGS. 1 to 4. As illustrated in FIG. 1, the liquid applying apparatus 100 includes an endless belt B as a conveyor for conveying a print target M in a conveyance direction. The endless belt B is horizontally bridged between a drive roller 10 and a driven roller 11. The drive roller 10 is driven to rotate counterclockwise by, for example, a motor to rotate the endless belt B in the direction indicated by the arrows in FIG. 1 (counterclockwise). The endless belt B can convey the print target M regardless of the size of the print target M (sheet size).

A humidifier 20 is disposed at the upstream end of a conveyance path of the endless belt B to apply water to the print target M. A dielectric heater 60 is disposed downstream from the humidifier 20 in the conveyance direction to heat the print target M. A liquid applier 70 is disposed downstream from the dielectric heater 60 in the conveyance direction to apply liquid to the print target M.

### Humidifier

As illustrated in FIG. 2, the humidifier 20 is coupled to a water tank 30 through a pump 40. A water purifier 21 attached to the humidifier 20 removes impurities from the water, which is supplied from the water tank 30 by the pump 40, to form pure water, and then the water (i.e., the pure water) is uniformly sprayed on the upper face of the print target M by thermal atomization through a minute nozzle 22 of the humidifier 20. Any nozzle can be used as the minute nozzle 22 as long as the water can applied to the print target M. Multiple nozzles may be arrayed in an array direction orthogonal to the conveyance direction. Such a configuration prevents the print target M from being unevenly heated by the dielectric heater 60. In addition, the duration of heating can be shortened due to an increase in the amount of water molecules contained in the print target M. In other words, the efficiency of heating can be enhanced. The minute nozzle 22 may be referred to simply as a nozzle.

### Dielectric Heater

The dielectric heater 60 includes, for example, a high-frequency dielectric heater or a microwave heater. Each of the high-frequency dielectric heater and the microwave heater vibrates the moisture in the print target M to heat the print target M.

An inner space of a housing 60a of the dielectric heater 60 is connected (coupled) to the humidifier 20 through a pipe 50. A vapor of the water (water vapor) generated from the print target M by the dielectric heater 60 flows back to the humidifier 20 through the pipe 50. In other words, the pipe 50 couples the dielectric heater 60 and the humidifier 20 to supply the water vapor to the humidifier 20.

The water vapor flows back to the humidifier 20, and then is sent to the minute nozzle 22 to reuse the water. The minute nozzle 22 thermally atomizes the water again to spray the atomized water on the upper face of the print target M. Such a configuration can reduce water consumption and enhance the thermal efficiency of a heating system.

A part of the endless belt B, on which the print target M is placed, passes through the housing 60a of the dielectric heater 60 to heat the print target M. The print target M can be sufficiently heated by the high-frequency dielectric heater or the microwave heater in the inner space of the housing 60a of the dielectric heater 60. The inner space of the housing 60a of the dielectric heater 60 has a sufficient space to which the water vapor evaporating from the print target M can escape. Thus, the dielectric heater 60 can sufficiently dry the print target M while heating the print target M before printing.

The high-frequency dielectric heater forms a high-frequency circuit using electromagnetic waves, such as high-frequency waves or very high-frequency waves in the frequency band of 3 MHz to 300 MHz, and dielectrically heats a heating target (e.g., the print target M) placed in a high-frequency electric field generated between electrodes on the high-frequency circuit. The microwave heater causes an oscillator to emit electromagnetic waves, such as ultra-high-frequency waves or centimeter waves in the frequency band of 300 MHz to 30 GHz, to form a high-frequency electric field, and dielectrically heats a heating target (e.g., the print target M) placed in the high-frequency electric field.

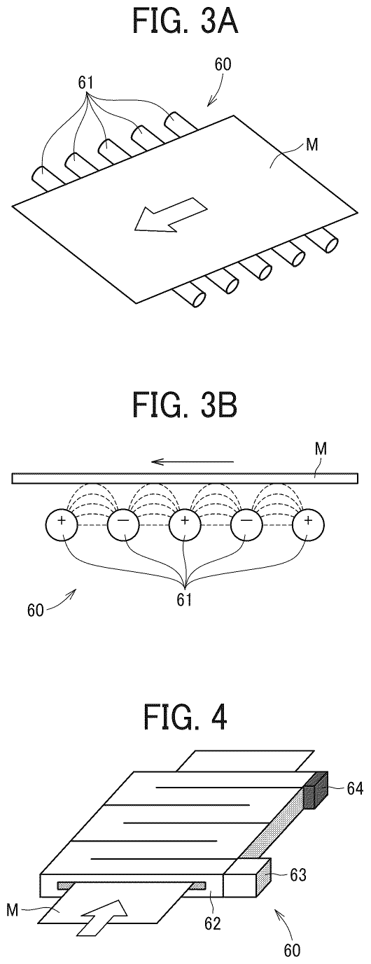

For example, as illustrated in FIGS. 3A and 3B, the high-frequency dielectric heater includes multiple rod-shaped electrodes 61, which are accommodated in the housing 60a. The multiple rod-shaped electrodes 61 are disposed in parallel at equal intervals below the print target M being conveyed along the conveyance path. Preferably, the orientation of the rod-shaped electrodes 61 is orthogonal to the conveyance path. In other words, the rod-shaped electrodes 61 is oriented in a width direction orthogonal to the conveyance direction. Such a configuration uniformly heats the print target M in the width direction.

A high-frequency applier applies high frequency to the multiple rod-shaped electrodes 61. Due to application of the high frequency to the rod-shaped electrodes 61, the print target M can be heated by dielectric heating. As the print target M is conveyed by the endless belt B in the direction indicated by the arrow in FIG. 3A or 3B, different regions of the print target M are sequentially heated.

As illustrated in FIG. 3B, the rod-shaped electrodes 61 are disposed such that the poles of the rod-shaped electrodes 61 are alternately different. For example, the high-frequency applier applies a high frequency of 100 MHz or less, more specifically, a high frequency of 10 MHz to 80 MHz to the rod-shaped electrodes 61. As a result, electric lines of force indicated by the dashed lines in FIG. 3B act on the print target M, causing a heating effect.

The level of the heating effect depends on materials. When a dielectric material is placed under high-frequency condition, heat corresponding to Ic·tanδ·E is generated, where δ represents dielectric loss (dielectric loss angle), E represents voltage, and Ic represents current. The tanδ is referred to as dielectric loss tangent. As the value of the dielectric loss tangent tanδ increases, the dielectric material is strongly heated. As the value of the dielectric loss tangent tanδ decreases, the dielectric material is less likely to be heated.

The drive frequency of the high-frequency dielectric heater is preferably 100 MHz or less. A drive frequency of 100 MHz or less enables a simple configuration of a shield that reduces unnecessary radiation. A commercially available printer has a gap for sheet feeding in the body thereof, and thus unnecessary radiation may leak through the gap due to higher frequency (shorter wavelength). However, when a drive frequency is 100 MHz or less, the leak of the unnecessary radiation can be reduced. In addition, a drive frequency of 100 MHz or less enables a simple electrode configuration.

As illustrated in FIG. 4, the microwave heater as the dielectric heater 60 includes a waveguide 62, a magnetron 63 for generating microwaves, and a reflective plate 64. The waveguide 62 has a multi-turn zigzag shape alternately turning stepwise from the magnetron 63 to the reflective plate 64. The microwave heater has no electrode, and the magnetron 63 generates microwaves having a frequency of 2450 MHz.

The generated microwaves are guided into an applicator by the waveguide 62 to form stationary waves, and the print target M passes through the stationary waves. This configuration is similar to the configuration of a microwave oven.

### Liquid Applier

The liquid applier 70 in FIG. 1 includes, for example, one inkjet head or multiple inkjet heads. Ink is supplied from an ink tank to the inkjet head. The inkjet head as the liquid applier 70 discharges small droplets of the ink to the print target M conveyed immediately below the liquid applier 70 to form an image on the print target M.

Although the embodiment of the present disclosure has been described above, embodiments of the present disclosure are not limited to the embodiment described above, and a variety of modifications can naturally be made within the scope of the technical idea described in the scope of the appended claims. For example, the liquid applier 70 may include one liquid applying head or multiple liquid applying heads instead of the inkjet head. The pressing force of the liquid applying head against the print target M is changed to adjust the amount of liquid to be applied.

Desired aspects of the present disclosure are as follows.

### Aspect 1

According to Aspect 1, a liquid applying apparatus includes a humidifier, a dielectric heater, and a liquid applier. The humidifier applies water to a print target being conveyed on a conveyance path. The dielectric heater heats the print target. The liquid applier applies liquid to the print target. The humidifier, the dielectric heater, and the liquid applier are disposed in this order from an upstream side to a downstream side of the conveyance path.

In other words, a liquid applying apparatus includes a liquid applier, a conveyor, a humidifier, and a dielectric heater. The liquid applier applies liquid to a print target. The conveyor conveys the print target to the liquid applier along a conveyance path in a conveyance direction. The humidifier is disposed upstream from the liquid applier in the conveyance direction. The humidifier applies water to the print target on the conveyance path. The dielectric heater is disposed downstream from the humidifier and upstream from the liquid applier in the conveyance direction. The dielectric heater heats the print target on the conveyance path and supplies the water generated from the print target to the humidifier.

### Aspect 2

According to Aspect 2, the liquid applying apparatus of Aspect 1 further includes a pipe through which an inner space of the dielectric heater is connected to the humidifier. A water vapor generated from the print target by the dielectric heater flows back to the humidifier through the pipe.

In other words, the liquid applying apparatus according to Aspect 1, further includes a pipe coupling the dielectric heater and the humidifier to supply a vapor of the water generated from the print target by the dielectric heater to the humidifier through the pipe.

### Aspect 3

According to Aspect 3, the liquid applying apparatus of Aspect 1 or 2 further includes a water tank outside the humidifier. The humidifier has a minute nozzle. The minute nozzle atomizes the water supplied from the water tank to spray the water atomized by the minute nozzle onto the print target.

In other words, the liquid applying apparatus according to Aspect 1 or 2, further includes a water tank outside the humidifier and coupled to the humidifier, to supply the water from the water tank to the humidifier. The humidifier has a nozzle to atomize the water supplied from the water tank to spray the water atomized from the nozzle to the print target.

### Aspect 4

According to Aspect 4, in the liquid applying apparatus of Aspect 3, the humidifier includes a water purifier. The water supplied from the water tank passes through the water purifier, and the minute nozzle atomizes the water.

In other words, the humidifier includes a water purifier to remove impurities from the water supplied from the water tank to supply pure water to the nozzle, and the nozzle atomizes the pure water.

### Aspect 5

According to Aspect 5, the liquid applying apparatus of any one of Aspects 1 to 4 further includes an endless belt disposed along the conveyance path to convey the print target.

In other words, in the liquid applying apparatus according to any one of Aspects 1 to 4, the conveyor includes an endless belt to form a part of the conveyance path.

### Aspect 6

The liquid applying apparatus according to Aspect 5, further includes a pipe coupling the dielectric heater and the humidifier. The dielectric heater includes multiple rod-shaped electrodes disposed in parallel at equal intervals below the print target conveyed along the endless belt and a housing through which a part of the endless belt passes. The housing accommodates the multiple rod-shaped electrodes and is coupled to the humidifier with the pipe. The rod-shaped electrodes are orientated in a width direction orthogonal to the conveyance direction. The rod-shaped electrodes adjacent to each other have poles alternately different. The dielectric heater applies frequency to the rod-shaped electrodes to heat the print target.

As described above, according to one aspect of the present disclosure, a dielectric heater can thermally dry a print target sufficiently.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid applying apparatus comprising:
a liquid applier to apply liquid to a print target;
a conveyor to convey the print target to the liquid applier along a conveyance path in a conveyance direction;
a humidifier upstream from the liquid applier in the conveyance direction, the humidifier to apply water to the print target on the conveyance path; and
a dielectric heater downstream from the humidifier and upstream from the liquid applier in the conveyance direction, the dielectric heater to:
heat the print target on the conveyance path; and
supply the water generated from the print target to the humidifier.

2. The liquid applying apparatus according to claim 1, further comprising a pipe coupling the dielectric heater and the humidifier to supply a vapor of the water generated from the print target by the dielectric heater to the humidifier through the pipe.

3. The liquid applying apparatus according to claim 1, further comprising a water tank outside the humidifier and coupled to the humidifier, to supply the water from the water tank to the humidifier,
wherein the humidifier has a nozzle to atomize the water supplied from the water tank to spray the water atomized from the nozzle to the print target.

4. The liquid applying apparatus according to claim 3,
wherein the humidifier includes a water purifier to remove impurities from the water supplied from the water tank to supply pure water to the nozzle, and
the nozzle atomizes the pure water.

5. The liquid applying apparatus according to claim 1,
wherein the conveyor includes an endless belt to form a part of the conveyance path.

6. The liquid applying apparatus according to claim 5, further comprising a pipe coupling the dielectric heater and the humidifier,
wherein the dielectric heater includes:
multiple rod-shaped electrodes disposed in parallel at equal intervals below the print target conveyed along the endless belt; and
a housing through which a part of the endless belt passes, the housing:
accommodating the multiple rod-shaped electrodes; and
coupled to the humidifier with the pipe,
wherein the rod-shaped electrodes are orientated in a width direction orthogonal to the conveyance direction,
the rod-shaped electrodes adjacent to each other have poles alternately different, and
the dielectric heater applies frequency to the rod-shaped electrodes to heat the print target.
